(19) United States
(12) Patent Application Publication
(10) Pub. No.: US 2008/0210357 A1
(43) Pub. Date: Sep. 4, 2008

(54) Vehicle Wheel Rim Designed For Mounting A Tyre And A Support

(76) Inventors: Marc Calvet, Clermont-Ferrand (FR); Guy Cagneaux, Nohanent (FR); Nicolas Janin, Riom (FR); Michel Malevergne, Cebazat (FR)

Correspondence Address: BUCHANAN, INGERSOLL & ROONEY PC, POST OFFICE BOX 1404, ALEXANDRIA, VA, 22313-1404, US

(21) Appl. No.: 11/631,814

(22) PCT Filed: Jun. 27, 2005
(86) PCT No.: PCT/EP2005/052990

§ 371 Date: Nov. 15, 2007

(30) Foreign Application Priority Data
Jul. 8, 2004 (FR) 0407580
Feb. 16, 2005 (FR) 0501579

(51) Int. Cl. B60B 21/10; B60B 21/02; B60B 21/04

(52) U.S. Cl. 152/379.5

(57) ABSTRACT

The object of the invention is a rotationally symmetric vehicle wheel rim (26) designed for the mounting of a tyre, comprising a first seat (30) intended to be positioned towards the inside of the vehicle and a second seat (32), the first seat (30) being extended axially towards the second seat (32) by a safety hump (40) and comprising a frustoconical bottom (34) which coincides locally with a cone of revolution (46) open towards the second seat (32) and coaxial with the rim (26), and an inner edge (36) which extends the bottom of the first seat (30) towards the second seat (32), such that on the hump side the inner edge (36) of the first seat (30) is tangential to a cone of revolution (48) coaxial with the rim (26) and open towards the second seat (32, with an apex angle larger than 103°.

### BACKGROUND

The present invention concerns a vehicle wheel rim designed for mounting a tire, having rim seats of the so-termed inverted type.

From the prior art and in particular from the document WO 01/08905 a rotationally symmetrical vehicle rim is known, which is designed for mounting a tire and comprises inverted rim seats, i.e. ones inclined towards the outside of the rim and not towards the inside as in the usual rims.

In the present description an assembly comprising a wheel, a tire mounted on the wheel and, optionally a tread support, is called a “mounted assembly”

The wheel comprises a rim, for example such as that described in the document WO 01/08905, and a disc.

In a mounted assembly the tire beads are in contact with the rim seats. The average diameters of the two seats are different in order to facilitate the mounting and removal of the support on the rim. In the rim described in WO 01/08905 the seat nearest the inside of the vehicle has the larger average diameter.

The support is carried circumferentially by a supporting surface of the rim located between the two seats. This consists for example of an elastomer material that can be deformed elastically, which prevents the tread from collapsing when the mounted assembly is rolling in a degraded condition, i.e. when the pressure in the tire is insufficient or zero.

In the remainder of this description, the term “unseating” is used to describe the fact that a bead has come off its supporting seat towards the outside of the rim, and the term “unwedging” to describe the fact that a bead has come off its supporting seat towards the inside of the rim.

To prevent unwedging of the bead on the seat having the larger average diameter, the rim described in WO 01/08905 is provided with a safety hump which extends the seat towards the inside of the rim. It is then said that the safety hump has an anti-unwedging function.

To evaluate the robustness of an anti-unwedging rim, the classical method is to subject a mounted assembly comprising the rim to various rolling tests in degraded conditions, in particular a test at zero pressure.

In particular, automobile manufacturers nowadays require the anti-unwedging function of the rims to be ensured correctly in a front wheel assembly, which is the one most highly stressed, in each of the following two extreme situations:

during a sustained emergency braking operation,

during a sustained bend.

Tests carried out on the rim described in WO 01/08905 have shown that the rim perfectly satisfies the current requirements of manufacturers in terms of anti-unwedging. The hump thus performs its anti-unwedging function appropriately.

Now, the inventors of the present invention thought of carrying out even more demanding tests of the mounted assembly fitted on the front wheels, by subjecting it to a rolling test in a degraded condition, during a sustained emergency braking operation with the front wheels steered.

The stresses undergone by the mounted assembly during this new type of test are considerably greater than those undergone by the mounted assembly during the tests carried out classically, so that the inventors were able to perceive ways to perfect the rim of the prior art beyond the usual anti-unwedging requirements of manufacturers.

More precisely, the inventors found that during this new test, unwedging could take place on the seat located on the inner side of the vehicle.

### SUMMARY OF THE INVENTION

Thus, the object of the invention is a rotating wheel rim for a vehicle, designed for the mounting of a tire and comprising a first seat intended for positioning on the inside of the vehicle and a second seat, the first seat being entended axially towards the second seat by a safety hump, and comprising:
a frustoconical bottom which coincides locally with a cone of revolution open towards the second seat and coaxial with the rim, and
an inner edge which extends the bottom of the first seat towards the second seat.

This rim is characterised in that on the side where the hump is, the inner edge of the first seat is tangential to a cone of revolution coaxial with the rim and open towards the second seat, with an apex angle larger than 103°.

The definition of a cone of revolution used is the common one, i.e. a solid of revolution with a circular base ending in a point.

Thanks to the invention, the edge of the first seat, orientated on the hump side, is sufficiently inclined to form a barrier which prevents the unwedging of the bead in contact with the first seat.

In a particular embodiment, on the hump side the inner edge of the first seat is tangential to a cone of revolution coaxial with the rim and open towards the second seat, with an apex angle larger than 110°. In effect, the inventors found that the rim is particularly robust against unwedging when the first seat has this characteristic.

Optionally, the first seat has an average diameter smaller than that of the second seat. In this embodiment it is the seat on the outside of the vehicle and closest to the wheel disc which has the larger diameter.

In another embodiment the average diameter of the first seat is larger than that of the second seat. In this embodiment, illustrated in the attached figures, it is the seat with the smaller average diameter which is positioned on the outside of the vehicle and closest to the wheel disc.

In a preferred embodiment the seat with the smaller average diameter is extended axially towards the seat with the larger average diameter by a tread support surface. This is the embodiment illustrated in the attached figures. However, the particular geometry, according to the invention, of the seat on the inside of the vehicle is also applicable in the case of a mounted assembly with no support and regardless of the diameters and respective positions of the rim seats.

In a first particular embodiment of the inner edge of the first seat, this coincides locally with the cone of revolution coaxial to the rim.

In a second particular embodiment, the inner edge of the first seat coincides locally with a torus coaxial with the rim, the torus being radially outside the first seat.

The definition of a torus used is the mathematical one, i.e. a surface of revolution produced by a circle rotating around an axis in its plane and not passing through its centre.

Optionally, the radius of curvature of the circular arc that generates the inner edge of the first seat is between 5 mm and 6 mm.

Optionally, the first seat has an outer edge which extends the bottom of the first seat in the direction opposite the inner edge.

Optionally, the outer edge of the first seat coincides locally with a torus coaxial with the rim, the torus being radially outside the first seat.

Advantageously, the rim is such that:
the outer edge of the first seat is shaped so that the cone that coincides with the bottom of the first seat intersects the torus coinciding with the outer edge of the first seat along two intersection circles,
Lₜ is the length of the convex envelope of the intersection of the first seat with the plane perpendicular to the axis of the rim, offset axially towards the second seat by 6 mm relative to the circle of intersection closest to the outer edge of the front seat,
Lₚ is defined as follows:
   in a first axial plane of the rim, the first seat and the hump define first and second profiles symmetrical relative to the axis of the rim,
   a point of connection between the bottom and the inner edge on the first profile, and a floating point on the second profile, enable a second plane normal to the first plane and containing the connection point and the floating point to be defined,
   Lₚ is then the maximum length of the convex envelope of the rim's intersection with the second plane, when the running point describes the second profile,
and such that:

$$for {L}_{t} \leq 1 , 510 mm \frac{{L}_{p}}{{L}_{t}} \geq [ [ 101 , 9 ] ] \underline{101.9} \% ; and$$

$$for {L}_{t} > 1 , 510 mm \frac{{L}_{p}}{{L}_{t}} \geq \frac{67594 - {L}_{t}}{64850} .$$

An axial plane is defined as a plane containing the axis of revolution of the rim.

To determine the optimum profile of the safety hump the inventors fabricated several rim prototypes. Each rim was subjected to anti-unwedging tests and tire mounting and removal tests.

The tests showed that to avoid unwedging it is advantageous to determine the exact geometry of the inner edge and the hump of the first rim seat in order to respect the above limits.

The tests also showed that it is desirable to respect the following values of the ratio

$$\frac{{L}_{p}}{{L}_{t}}$$

if the removal of the tire from the rim is always to be possible under normal conditions:

$$\frac{{L}_{p}}{{L}_{t}} \leq \frac{55925 - {L}_{t}}{53333}$$

Preferably, for a wheel diameter smaller than 460 mm or for:
Lₜ≦1,500 mm the value of the said ratio is:

$$\frac{{L}_{p}}{{L}_{t}} \leq 102.1 \% .$$

In a particular embodiment, the safety hump has a frustoconical portion which coincides locally with a cone of revolution open towards the first seat and coaxial with the rim.

In a particular embodiment the safety hump has a cylindrical portion which coincides locally with a cylinder of revolution coaxial with the rim and which extends the frustoconical portion of the hump towards the first seat.

### BRIEF DESCRIPTION OF THE DRAWINGS

The invention will be better understood on reading the description below, which is given only as an example and refers to the drawings, in which:

FIG. 1 is an axial sectional view of a mounted assembly comprising a tire and a rim according to the invention,

FIG. 2 is a detailed fragmentary view of the axial section of the rim shown in FIG. 1,

FIG. 3 is a detailed fragmentary view of the seat with the larger diameter, of the rim shown in FIG. 2,

FIG. 4 is a view similar to FIG. 3 of a variant of the seat shown in FIG. 3, and

FIG. 5 is a fragmentary detailed view of the seat with the larger diameter, of the rim shown in FIG. 2.

### DETAILED DESCRIPTION OF PREFERRED EMBODIMENTS

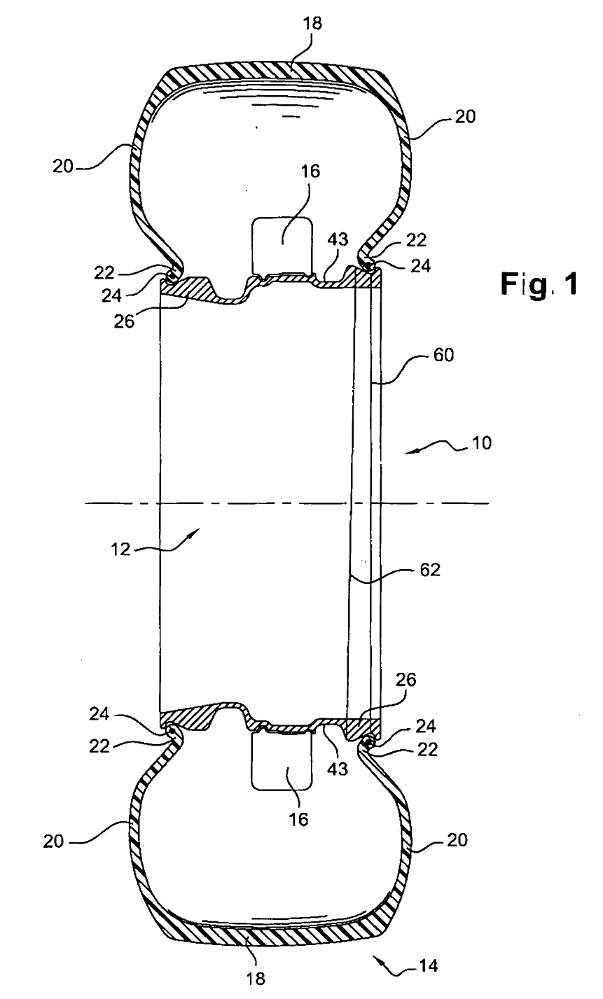

FIG. 1 shows a mounted assembly denoted by the general index 10, viewed in section along an axial plane, i.e., the plane of the paper. The mounted assembly is essentially rotationally symmetrical and comprises a wheel 12, a tire 14 and a tread support 16.

The tire 12 classically comprises a tread 18 connected by two sidewalls 20 to two beads 22. It is reinforced by a radial carcass reinforcement formed of a ply (not shown) of cords which are usually textile (although other types or natures of reinforcements are also possible) anchored in each bead 22 around a bead wire 24.

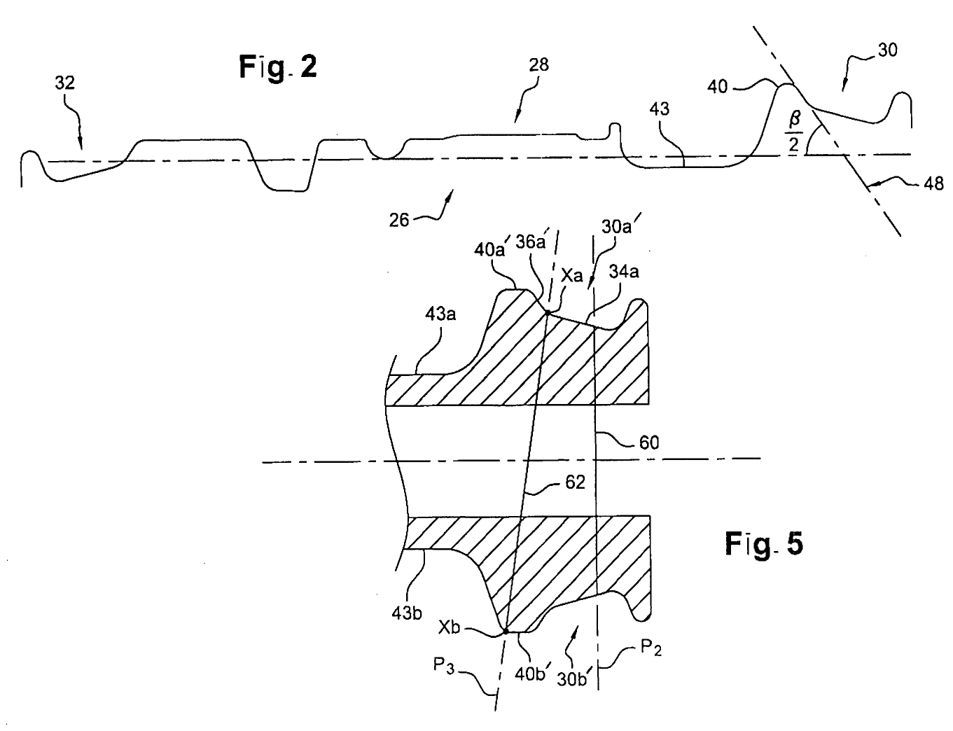

The wheel 12 comprises a rim 26 shown in more detail in FIG. 2. Viewed in the axial section of FIG. 1 are two diametrically opposite profiles of the rim 26 which are symmetrical in relation to the axis of the mounted assembly. Only one of the two profiles is shown in FIG. 2.

The rim 26 has a supporting surface 28 designed to support the tread support 16.

The rim 26 also comprises first 30 and second 32 seats with which the beads 22 are in contact. The first seat 30 has an average diameter larger than that of the second seat 32 (FIG. 1). When the wheel is mounted on a vehicle, the first seat faces towards the vehicle.

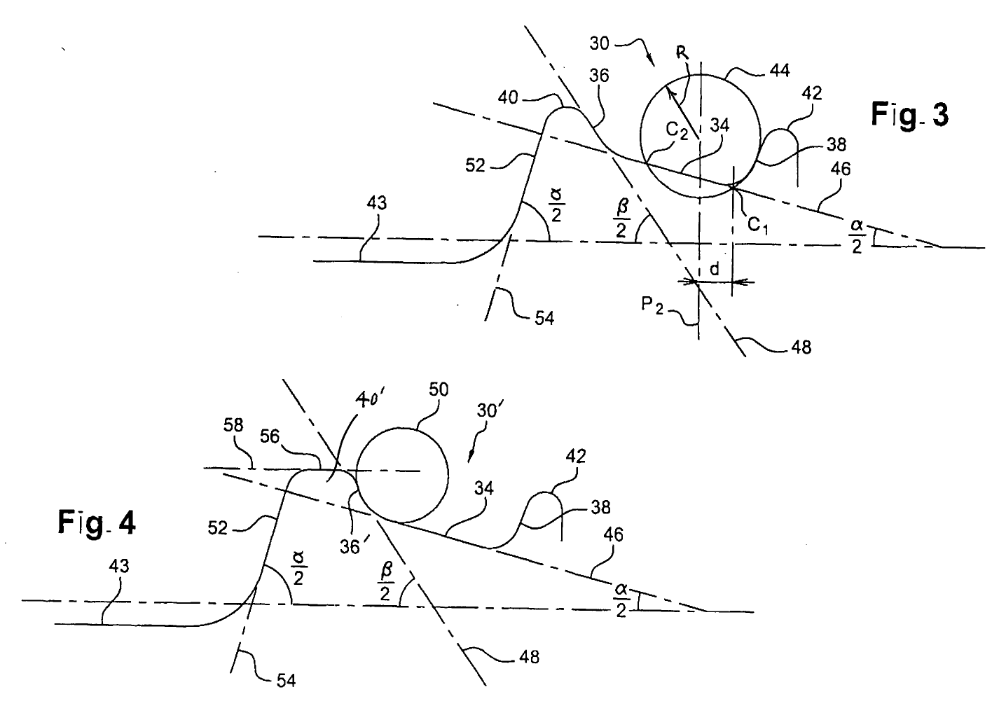

The first seat 30, shown in more detail in FIG. 3, comprises a bottom 34, an inner edge 36 which extends the bottom 24 towards the second seat 32, and an outer edge 38 which extends the bottom 34 in the direction opposite the inner edge 36.

The inner edge 36 is extended towards the second seat 32 by a safety hump 40, and the outer edge 38 is extended opposite the bottom 34 by a projection 42.

The safety hump 40 is extended towards the second seat 32 by a mounting groove 43.

The outer edge 38 coincides locally with a torus 44 coaxial with the rim. The generatrix circle of the torus 44 is of radius R essentially equal to 12 mm.

The bottom 34 coincides locally with a cone of revolution 46 open towards the second seat 32, coaxial with the rim 26 and with an apex angle α essentially equal to 30°. One then speaks of a frustoconical bottom 34.

In a first embodiment shown in FIG. 3, the inner edge 36 coincides locally with a cone of revolution 48 open towards the second seat 32, coaxial with the rim 26 and with an apex angle β larger than 103°, essentially equal to 115°.

In a second embodiment shown in FIG. 4 the inner edge 36, 36′ of the first seat 30′ coincides locally with a torus 50 coaxial with the rim 26, the generatrix circle of the torus 50 having radius essentially equal to 5.5 mm. The inner edge 36′ is adjacent to the hump 40′. In this case the inner edge is tangential to the cone 48 of apex angle larger than 110°, here about 115°, at the level of the point of inflexion between the inner edge and the first (inner) part of the hump 40′, which is also circular but with inverted curvature.

Consequently, in both embodiments the inner edge 36 is tangential to the cone 48.

The safety hump 40 (and 40′) comprises a frustoconical portion 52 which coincides locally with a cone of revolution 54 open towards the first seat 30, coaxial with the rim 26, and with apex angle γ essentially equal to 150°.

In the particular embodiment of the safety hump 40′ shown in FIG. 4, the safety hump 40′ also has a cylindrical portion 56 which coincides locally with a cylinder of revolution 58 coaxial with the rim 26 and which extends the frustoconical portion 52 of the hump towards the inner edge 36 of the first seat 30′.

To appreciate the quality of the anti-unwedging function of the safety hump 40, 40′ from the simple geometrical definition of the hump, the lengths Lₜ and Lₚ are introduced, whose calculation will now be explained in detail.

The cone 46 intersects the torus 44 along two circles of intersection C₁ and C₂, with C₁ being closest to the outer edge of the first seat 30, and the circles being coaxial with the rim.

The plane perpendicular to the axis of the rim 26 and offset axially towards the second seat 32 by a distance d equal to 6 mm relative to the circle C₁, is denoted P₂.

The length Lₜ is then equal to the length of the convex envelope 60 of the intersection of the first seat 30 (i.e., the bottom 34 in FIG. 3) with the plane P₂. If the first seat is perfectly rotationally symmetrical, this intersection is a circle and the length Lₜ is equal to the perimeter of that circle.

The value of d is chosen arbitrarily so as to obtain a reference length Lₜ essentially equal to the perimeter of the first seat and to the inner perimeter of the bead 22 of the tire 14.

FIG. 5 shows an axial section view through the first seat 30, in which the two diametrically opposite (i.e., upper and lower) symmetrical profiles are shown.

For the sake of clarity, the scale between the first seat and the radius of the rim is not respected in FIG. 5.

The index a is used to describe elements of the upper profile and the index b to describe those of the lower profile.

Xa is the point of connection between the bottom 34a and the inner edge 36a.

Xb is a floating point on the safety hump 40b′ of the first seat 30b′.

A plane P₃ normal to the plane of the paper in FIG. 5 contains points Xa and Xb.

The length Lₚ is equal to the maximum length of the convex envelope 62 of the intersection of the rim 26 with the plane P_{3′} when the point Xb lies on the safety hump 40b′ of the first seat 30b.

The value Lₚ corresponds essentially to the value which the inner perimeter of the bead 22 of the tire 14 must exceed during a tire removal or an unwedging operation.

The ratio between the two lengths Lₚ and Lₜ defined above must be such that, on the one hand, the anti-unwedging function is properly ensured by the safety hump 40, 40′ and, on the other hand, the mounting and removal of the tire 14 on the wheel 12 remains possible using classical garage tools.

The operations of mounting a tire and a support on a rim according to the invention are described, in particular, in the document FR 2 819 218 (corresponding to U.S. Publication No. 2004/0074610). The presence of the mounting groove 43 enables this mounting to be carried out without the ratio

$$\frac{{L}_{p}}{{L}_{t}}$$

being decisive. In contrast, the tire bead positioned on the first seat 30, 30′ is removed by the progressive pressure of a roller against the bead axially towards the mounting groove, while the mounted assembly is rotated slowly. This pressure displaces the bead locally and causes it progressively to pass over the inner edge of the rim and then the safety hump. The bead then falls into the mounting groove. It is for this operation that the ratio

$$\frac{{L}_{p}}{{L}_{t}}$$

is decisive.

Tests carried out by the inventors have shown that it is advantageous for the rim to be such that the following relationships are respected in order to limit unwedging phenomena:

$$for {L}_{t} \leq 1 , 510 mm \frac{{L}_{P}}{{L}_{t}} \geq 101.9 \% ; and$$

$$for {L}_{t} > 1 , 510 mm \frac{{L}_{p}}{{L}_{t}} \geq \frac{67594 - {L}_{t}}{64850} .$$

It is found that as the value of Lₜ (related to the diameter of the rim) increases, the minimum limit of the ratio

$$\frac{{L}_{p}}{{L}_{t}}$$

to be respected decreases.

The tests also showed that to enable tires to be removed from their rims under conditions acceptable in workshops or garages, it is also desirable to respect the following limits:

$$\frac{{L}_{P}}{{L}_{t}} \leq \frac{55925 - {L}_{t}}{5333}$$

For small diameters such as 420 and 440 mm, it is also preferable to respect the following limit:

$$for {L}_{t} \leq 1 , 510 mm \frac{{L}_{P}}{{L}_{t}} \leq 102.1 \%$$

Observation of the two groups of limits shows that the more the rim diameter increases, the narrower is the definition zone of the geometry of the first seat and the hump adjacent to it.

The tests carried out varied the geometry of the inner edge in accordance with the variants of FIGS. 3 and 4, the height of the hump 40, 40′ in relation to the rim diameters, and the axial width 56 of the hump 40 in the variant of FIG. 4.

Note, finally, that the invention is not limited to the embodiments described above while it remains within the scope of the claims below.

1-15. (canceled)

16. Rotationally symmetrical vehicle rim designed for the mounting of a tire, comprising first and second seats arranged to be positioned towards the inside and outside, respectively, of the vehicle, the first seat being extended axially towards the second seat by a safety hump and comprising:
a frustoconical bottom which coincides locally with a first cone of revolution open towards the second seat coaxially with the rim; and
an inner edge which extends the bottom of the first seat towards the second seat and forms a side of the hump;
wherein the inner edge of the first seat is tangential to a second cone of revolution opening towards the second seat coaxially with the rim, with an apex angle larger than 103°.

17. Rim according to claim 16, wherein the apex angle of the second cone is larger than 110°.

18. Rim according to claim 16, wherein the first seat has an average diameter smaller than that of the second seat.

19. Rim according to claim 18, wherein the seat with the smaller average diameter is extended axially towards the seat with the larger average diameter by a supporting surface to support a tread support ring.

20. Rim according to claim 16, wherein the first seat has an average diameter larger than that of the second seat.

21. Rim according to claim 20, wherein the seat with the smaller average diameter is extended toward the seat with the larger average diameter by a supporting surface to support a tread support ring.

22. Rim according to claim 16, wherein the inner edge of the first seat coincides locally with the cone of revolution coaxial with the rim.

23. Rim according to claim 16, wherein the inner edge of the first seat coincides locally with a torus coaxial with the rim, the torus being radially outside the first seat.

24. Rim according to claim 23, wherein the inner edge of the first seat is defined by a circular arc generatrix having a radius of curvature in the range of 5 mm to 6 mm.

25. Rim according to claim 16, wherein the first seat has an outer edge which extends the base of the first seat in a direction opposite to the inner edge.

26. Rim according to claim 25, wherein the outer edge of the first seat coincides locally with a torus coaxial with the rim, the torus being radially outside the first seat.

27. Rim according to claim 26, wherein:
the outer edge of the first seat is shaped such that the first cone of revolution intersects the torus along two circles (C₁, C₂) of intersection,
a first convex envelope is formed by an intersection of the first seat with a plane (P₂) which is perpendicular to the axis of the rim and is offset axially towards the second seat a distance of 6 mm relative to the circle of intersection (C₁) closest to the outer edge of the first seat, the first convex envelope having a first length (Lₜ),
in an axial first plane through the rim, the first seat and the hump together define first and second diametrically opposite profiles which are symmetrical relative to the axis of the rim,
a second plane (P₃) normal to the first plane intersects:
a connection point on the first profile (Xa) joining the bottom to the inner edge, and a floating point (Xb) on the second profile, and
a second convex envelope is formed by the intersection of the rim with the second plane (P₃), wherein the second convex envelope has a second length (Lₜ),
wherein:
$$for {L}_{t} \leq 1 , 510 mm \frac{{L}_{P}}{{L}_{t}} \geq 101.9 \% ; and$$
$$for {L}_{t} > 1 , 510 mm \frac{{L}_{P}}{{L}_{t}} \geq \frac{67594 - {L}_{t}}{64850} .$$

28. Rim according to claim 27 wherein:
$$\frac{{L}_{P}}{{L}_{t}} \leq \frac{55925 - {L}_{t}}{53333}$$

29. Rim according to claim 28 wherein:
$$for {L}_{t} \leq 1 , 510 mm \frac{{L}_{P}}{{L}_{t}} \leq 102.1 \% .$$

30. Rim according to claim 16, wherein the safety hump comprises a frustoconical portion which coincides locally with a cone of revolution open toward the first seat coaxially with the rim.

31. Rim according to claim 30, wherein the safety hump comprises a cylindrical portion which coincides with a cylinder of revolution coaxial with the rim and which includes a frustoconical portion that is extended towards the first seat.
